(19) United States
(12) Patent Application Publication
(10) Pub. No.: US 2016/0303616 A1
(43) Pub. Date: Oct. 20, 2016

(54) METHOD AND APPARATUS FOR CAPPING AND SERVICING AN INK-JET PRINTHEAD IN A 3D PRINTER

(71) Applicant: 3DBotics, Inc., Dearborn, MI (US)

(72) Inventors: James F. Bredt, Watertown, MA (US); Kate Van Rees, Needham, MA (US)

(21) Appl. No.: 15/099,740

(22) Filed: Apr. 15, 2016

Related U.S. Application Data
(60) Provisional application No. 62/149,297, filed on Apr. 17, 2015.

(51) Int. Cl. B08B 3/10; B65B 3/14; B08B 3/12; B29C 67/00; B08B 3/08

(52) U.S. Cl. CPC B08B 3/10; B29C 67/0081; B29C 67/0096; B08B 3/08; B08B 3/12; B65B 3/14; B33Y 30/00

(57) ABSTRACT

A 3D printing apparatus including a manifold configured to receive a printing element; and a gasket disposed at a lower portion of the manifold. The manifold and gasket enclose the printing element, and the gasket defines a liquid-tight seal isolating the printing element from ambient. In another embodiment, a 3D printing apparatus includes a printing element; a manifold configured to receive the printing element; and a gasket disposed proximate the printing element, with the manifold and gasket together enclosing the printing element, and the gasket defining a liquid-tight seal that isolates the printing element from ambient. A service apparatus for washing a printing element, the apparatus including a parking element having at least one surface, and a frame defining a plurality of channels for introducing and draining a liquid solution when a printing element is parked against the surface of the parking element. Methods for capping, washing, preserving, and storing printing elements.

### CROSS REFERENCE TO RELATED APPLICATIONS

This application claims the benefit of priority to U.S. Provisional Application Ser. No. 62/149,297 filed Apr. 17, 2015, which is incorporated herein by reference in its entirety.

### FIELD

Embodiments of the invention relate generally to three-dimensional printing (“3D printing”) and in particular to methods and equipment for 3D printing.

### BACKGROUND

Three dimensional printers are divided into several categories based on the methods used for dispensing materials. One of these categories encompasses the use of ink-jet printing with a powdered or granular substrate. An exemplary granular-substrate ink-jet method is described in U.S. Pat. No. 5,204,055, incorporated herein by reference in its entirety. A moving ink-jet printhead is used to dispense, e.g., print, a liquid ink onto a stationary level substrate comprising a granular material, e.g., a powder, confined to a region of the machine referred to as the build area. Motion of the printhead relative to the substrate and other stationary components is provided by a robot to which the printhead is attached. The union of the ink and the powder forms a solid portion of material in the location printed. A three dimensional article is formed by first printing a cross sectional layer on the substrate, then spreading a further layer of powder over the first layer, and printing a second cross-sectional layer in the same general location as the first. Layers bond together in sequence, forming a solid three-dimensional article. After a relatively large number of layers are printed in this manner, the solid article may be removed from loose, unbound powder (i.e., powder that has not received a dose of ink) after a suitable curing time has passed.

A persistent difficulty encountered with 3D printing equipment, especially those using ink-jets over a powdered substrate, is maintenance of the printing element. This arises from the combination of several requirements for building accurate 3D articles: (1) The printing element preferably travels relatively close to the substrate to ensure accurate printing; (2) the powder is preferably relatively flowable in its unprinted state to facilitate the formation of flat layers on the substrate; and (3) the combination of ink and powder typically form a durable solid when they mix. The combination of these three factors ensures the ambient environment around the printing element tends to be dusty and the dust tends to form tenacious deposits on the printing elements of the machine.

### SUMMARY

In an aspect, a 3D printing apparatus includes a printing element, and a manifold configured to receive the printing element. A gasket is disposed proximate the printing element. The manifold and gasket together enclose the printing element, and the gasket defines a liquid-tight seal that isolates the printing element from ambient.

One or more of the following features may be included: The gasket may include a highly flexible, hydrophobic material, such as EPDM rubber, fluoroelastomers, and/or polydimethylsiloxane.

The gasket may include a flexible component coupled with a rigid support. The gasket may be adapted to become distorted when it is mated to the printing element in an interference fit, the distortion causing the liquid-tight seal to become compressed at an interface between the gasket and the manifold.

The apparatus may include a robot adapted to move the printing element, manifold, and gasket. The robot may be adapted to move a plurality of assembled printing elements, manifolds, and gaskets.

In another aspect, a 3D printing apparatus includes a manifold configured to receive a printing element, and a gasket disposed at a lower portion of the manifold. The manifold and gasket are adapted to together enclose the printing element, and the gasket defines a liquid-tight seal that isolates the printing element from ambient.

A service station may be adapted to service the printing element. The service station may include a parking element having at least one surface, e.g., a flat surface.

In another aspect, a method for capping a printing element is provided. A 3D printing apparatus may be provided, including a printing element, a manifold configured to receive the printing element, a gasket disposed proximate the printing element, and a service station adapted to service the printing element, the service station including a parking element having at least one surface. The manifold and gasket together enclose the printing element, and the gasket defines a liquid-tight seal that isolates the printing element from ambient. The printing element is positioned against the surface of the service station. The printing element is pressed against the surface, with the surface compressing the gasket to tighten the liquid-tight seal.

In still another aspect, a service apparatus for washing a printing element is provided. The apparatus includes a parking element having at least one surface, e.g., a flat surface, and a frame defining a plurality of channels or tubes for introducing and draining a liquid solution when the printing element is parked against the parking element.

In another aspect, a method for washing a printing element is provided. In accordance with the aspect, a 3D printing apparatus is provided, including a printing element, a manifold configured to receive the printing element, and a gasket disposed proximate the printing element. The manifold and gasket together enclose the printing element, and the gasket defines a liquid-tight seal that isolates the printing element from ambient.

The 3D printing apparatus is positioned against a service apparatus including a parking element having at least one surface, and a frame defining a plurality of channels for introducing and draining a liquid solution when the printing element is parked against the surface of the parking element. The channels are in fluidic communication with a space between the gasket and an orifice plate of the printing element. A fluid is supplied from at least one inlet channel to a space between the gasket and the orifice plate. A negative pressure is applied to an outlet channel. The fluid is drained through the outlet channel.

One or more of the following features may be included. Supplying the fluid may include pressurizing the fluid in the printing element. The printing element may apply the negative pressure. A first fluid may be supplied through the inlet channel, a second fluid may be supplied through the printing element, and the product of reaction between the two fluids effects cleaning of an orifice plate on the printing element.

Acoustic energy from an acoustic energy source may be applied to the fluid occupying the space between the gasket and orifice plate. The source of acoustic energy may be a piezoelectric actuator of the printing element.

In still another aspect, a method for preserving and storing a printing element is provided. In accordance with the aspect, a 3D printing apparatus is provided, including a printing element, a manifold configured to receive the printing element, and a gasket disposed proximate the printing element. The manifold and gasket together enclose the printing element, and the gasket defines a liquid-tight seal that isolates the printing element from ambient.

The 3D printing apparatus is positioned against a service apparatus that includes a parking element having at least one surface, and a frame defining a plurality of channels for introducing and draining a liquid solution when the printing element is parked against the surface of the parking element. The channels are in fluidic communication with a space between the gasket and an orifice plate of the printing element. A storage fluid is supplied from at least one channel to the space between the gasket and the orifice plate.

One or more of the following features may be included. A vacuum may be applied to the printing element, to cause the storage fluid to replace at least a portion of an ink disposed in the printing element, the storage fluid including a nonvolatile, inert solvent miscible with the ink, and the ink including a binder for 3D printing. The printing element may be positioned against an impermeable surface to seal the storage fluid within the printing element.

### BRIEF DESCRIPTION OF FIGURES

FIG. 1 is an exploded schematic diagram illustrating a manifold assembly including a single manifold block, printing element, and gasket viewed from below, in accordance with an embodiment of the invention;

FIG. 2a is a schematic view of a manifold assembly in accordance with the present disclosure, including a manifold, a printing element, and a dogbone gasket;

FIG. 2b is a detailed schematic view of a gasket and printing element before assembly, in accordance with the present disclosure;

FIG. 2c is a detailed schematic view of an interference fit between a printing element and gasket, in accordance with the present disclosure;

FIG. 2d is a schematic view of the compression of a gasket when a print element is parked on flat surface, in accordance with the present disclosure;

FIG. 3a is a cross-sectional view of an irrigation site on a printhead service station, in accordance with the present disclosure;

FIG. 3b is a schematic view illustrating an area of contact between a dogbone gasket and an irrigation site on a service station, in accordance with the present disclosure; and

FIG. 3c is a cross-sectional view of a portion of an orifice plate and irrigation site on a service station, in accordance with the present disclosure.

### DETAILED DESCRIPTION

As used herein, the term “powder” means granular material used as a substrate in a 3D printing process. The term “ink” means a liquid component dispensed onto the powder to define a three-dimensional article in a 3D printing process. An ink can include a chemical substance that activates adhesive components contained in the powder, or it may itself include an adhesive, or it may include a fluid with no adhesive action, e.g. a conventional dye-based ink used for marking the substrate.

As used herein, the term “print” means the action of dispensing a liquid ink over a powdered substrate.

As used herein, the term “printhead” means an assembly of printing hardware that is manipulated as a unit in a 3D printer to dispense ink during the printing process. An example of a commercially available printhead suitable for use with embodiments of the invention is RHB-12, available from 3dbotics, Inc of Woburn, Mass. The term “printing element” means a subcomponent of the printhead, i.e., a single device that ejects ink when it receives electronic signals. An example of a commercially available printing element is a QS80 “Sapphire” available from Fujifilm/Dimatix of Lebanon, N.H.. A printhead may include several printing elements, mounting hardware, fluid connections, electronic connections, and components attached to the printhead to protect the printing elements from damage and facilitate maintenance. Components of a printing element include an “orifice plate,” i.e., a mechanical component defining one or several holes through which ink is ejected in the form of a jet. Other components include fluid inlets through which ink is supplied, a stimulation device that may include a piezoelectric element providing acoustic energy that ejects liquid ink through the orifice plate, and electronic components that receive signals from the outside and control the flow of ink through the orifice plate.

An embodiment of the instant invention also includes a service station. This is a component that sits in a particular location outside of the build area and includes a set of devices for cleaning the printhead, most particularly the orifice plates on individual printing elements and areas immediately surrounding them. The service station may additionally include a capping station, whose purpose is to cover the orifice plates when they are not in use, to protect them from ambient dust, and to prevent them from drying out or otherwise reacting with the ambient atmosphere.

In U.S. Patent Publication No. 2015/0251354 A1, incorporated herein by reference in its entirety, a geometric arrangement of printing elements in a printhead is disclosed that ensures nearly all of the dust ejected by the printing process moves away from the printing elements. Embodiments of the instant invention provide an additional mechanical means for protecting the printhead from dust, and for cleaning it when dust happens to collect on it.

The principal method for cleaning a printhead that has accumulated some dust is to wash the orifice plates of the printing elements with a liquid. This may be accomplished either by supplying a stream of liquid from an external source, or by pressurizing the ink within the head (a process known as pressure-priming) to expel deposits from the vicinity of the orifice plates. In both of these methods, a stream of liquid arrives at the external surface of the printhead that greatly exceeds the quantity expelled during normal printing. This liquid is preferably excluded from the vicinity of the electronic components and cleared away at the conclusion of the cleaning process to make a free path between the individual ink jets and the powder.

Embodiments include a rigidly supported flexible gasket that forms a liquid-tight seal around the orifice plates and is integrated with the printhead, combined with a stationary service station that sits in a particular location outside of the build area of the 3D printer. The gasket that surrounds the orifice plate forms a barrier to protect electronic components, protects the fragile orifice plate while facilitating wiping of the head, and provides an interface with the service station. The service station includes a fixed arrangement of components. All motion of the printhead relative to the service station may be provided by a robot.

In a preferred embodiment, printhead components are encapsulated in a modular envelope (i.e., a manifold) that allows convenient supply of fluid and electronic signals, and allows accurate alignment and support of individual printing elements in an array that includes the printhead. The gasket described herein is preferably integrated into the manifold and travels with it. It provides a liquid-tight barrier between the electronic components of the head and the path taken by the fluid, and provides mechanical protection of the delicate printing elements of the printhead during operation, assembly, handling, and service.

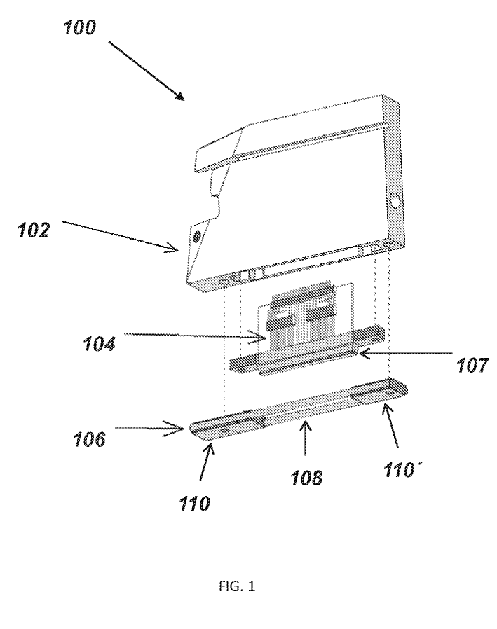

Referring to FIG. 1, an exploded diagram of a manifold assembly 100 includes a single manifold block 102, a printing element 104, and a gasket 106 viewed from below. Details in each component are shown for illustrative purposes only. Fasteners, fluid fittings, and electronic connections are not shown. The printing element 104 nests inside the manifold block 102, and the gasket 106 is assembled over it. The gasket 106 encloses the orifice plate on the printing element 104 and protects it from damage. Electronic components that are part of the printing element 104 (shown for illustrative purposes only) are preferably enclosed by the gasket 106 in a slot in the manifold. The orifice plate on the lower surface of the printing element 104 may mate with the slot in the gasket 106 and may be configured to communicate fluid to the outside world.

To make an effective seal around a slender rectangular orifice plate, a soft rubber gasket 106 is preferably mechanically supported around its entire circumference. The design of the gasket 106 that travels with the manifold 102 preferably incorporates a rigid structure that provides support. In one embodiment, the mechanical support is provided by a metallic plate that carries multiple printing elements 104 that project through narrow slots in the plate. In a preferred embodiment the gasket support element 108 is a slotted bar of metal (referred to herein as a “dogbone” design) that attaches to the manifold 102 containing a single printing element 104. This configuration may provide the advantage of enabling the single assembly to be used as a modular component in different printhead configurations. By way of example, a dogbone gasket support element 108 is shown in FIG. 1.

A typical multi-channel printing element is exemplified by the U-Series products manufactured by FujiFilm/Dimatix. The orifice plate may be a rectangle with a width selected from a range of 0.5 mm to 20 mm and a length of 0.5 mm to 200 mm. One or more holes, e.g., 1 to 4096 holes may be defined in the orifice plate, each hole having a diameter selected from a range of 0.005 mm to 0.5 mm, with spacing of 0.005 mm to 0.5 mm between the holes. In a particular embodiment, the orifice plate may be a rectangle 5 mm wide and 80 mm long with 256 holes etched into it in a single line with 0.01 inches between holes.

A gasket 106 appropriate for this printhead possesses a rectangular slot that slightly overlaps the orifice plate, for example the slot may be 3.5 mm wide and 77 mm long, in the case of the exemplary plate of 5 mm wide and 80 mm long. The bottom surface of the gasket 106 may be flat, while the top surface may have depressions and asperities that enclose various physical features of the printing element 104. Most particularly, the gasket 106 may include a rectangular ridge that fits the outside dimensions of the orifice plate, e.g., 5 mm×80 mm in this example. This provides a sealing surface around the circumference of the orifice plate and retards the flow of fluid upwards from the orifice plate to the regions where active electronic components.

The gasket 106 is typically made of a soft, flexible material such as silicone rubber. To hold it in the proper orientation with respect to the orifice plate, a rigid support is provided by the dogbone gasket support element 108. The dogbone support element 108 is essentially a metallic object with a rectangular slot that surrounds the orifice plate with a clearance of at least a few millimeters. By way of example, the slot in the dogbone 108 may be 88 mm long and 13 mm wide to provide 4 mm of clearance around an orifice plate having dimensions of 5 mm×80 mm, allowing enough space for the contours of the rubber gasket 106. The gasket 106 may be molded over the dogbone gasket support element 108 such that the dogbone support element 108 is embedded in the rubber and holds the gasket 106 securely in place.

The rubber gasket 106 supported by each dogbone support element 108 preferably defines a narrow slot through which the jets of the printing element 104 may eject fluid onto the powder. The width of the slot is preferably slightly less than the width of the orifice plate, and may be provided with a positioning feature such as a ridge. This positioning feature permits the orifice plate to mate with a corresponding slot or other locating feature in the flexible gasket 106 around its entire circumference. The rubber gasket 106 and dogbone support element 108 may be coupled to the orifice plate with coupling elements 110, 110′. The coupling elements form the end pieces for the rubber gasket/dogbone support element assembly, and provide the anchoring points for the structure supporting the gasket. The coupling elements are integral parts of the metallic portions of the dogbones, forming the end pieces of the structure that support thinner members that support the narrow slot in the rubber gasket and pass along the length of the orifice plate. The dogbone is aligned and attached to the manifold by screws threaded through holes in the coupling elements into threaded inserts pressed into the lower corners of the manifold, adjacent to the slot that contains the printing element. In the event of a collision between the printhead and an external object, these anchoring points transfer the force of impact away from the printing element, through the manifold, and into the frame of the machine.

When the gasket 106 and dogbone gasket support element 108 are assembled with the printing element 104 and manifold block 102, it may be preferred that the printing element 104 press into the mating slot in the gasket 106 a short distance, with a small ‘interference’ fit of, e.g., roughly 1 mm. This provides some extra mechanical force against the mating surface and ensures a liquid-tight seal.

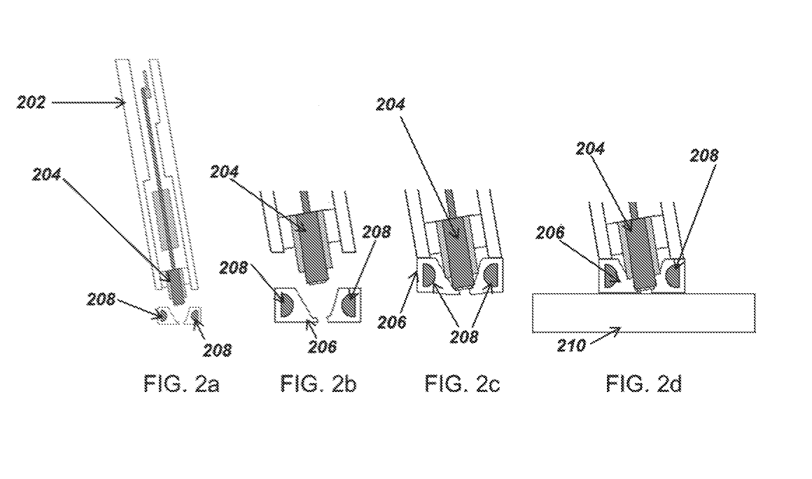

Referring to FIGS. 2a-2d, the interference fit between the printing element 204 and the gasket 206 may tend to force the gasket outwards a short distance from the lowest plane of the printhead. In particular, FIGS. 2a-2d include cross-sectional views showing how insertion of the printing element 204 into the gasket 206 forces the gasket 206 out into a convex pair of lips that surround the slot. The dogbone gasket support 208 is illustrated in FIGS. 2a-2d as two semicircular shapes embedded in the gasket that encloses the orifice plate. FIG. 2a is an overall view of the manifold 202, printing element 204, gasket 206, and dogbone gasket support element 208. FIG. 2b is a detailed view of the gasket 206 and printing element 204 before assembly. FIG. 2c is a detailed view of an interference fit between the printing element 204 and the gasket 206. Note that the lower edge of the gasket 206 is pressed downward into a convex profile. FIG. 2d illustrates compression of the gasket 206 when the print element 204 is parked on a parking element 210 on a flat surface. The compression may squeeze the gasket 206 flat.

As used herein, a ‘parking element’ 210 is a solid feature located on a stationary structure that stands outside of the build area of the machine. This feature provides a mating surface for the dogbone gasket 208 at times when the printhead is not in use. In a particular embodiment, the parking element 210 may be a body of flexible material with a flat upper surface against which the dogbone gasket support element 208 (that travels with the printhead) may be placed. It provides mechanical compression of the dogbone gasket 208 around the orifice plate and ensures a seal against the edges of the plate, preventing drying of the printing element 204. This mode of compression is illustrated in FIG. 2d. Further, the flat upper surface facilitates cleaning of the parking element 210 to prevent dust accumulation that may otherwise be deposited on the orifice plate. The printing element 204 may be made from a chemically resistant flexible material selected from the same group as those indicated above for the dogbone gasket support element 208. In some preferred embodiments, the printing element 204 may be made from the same material as the dogbone gasket support element 208.

The parking element 210 may include a supporting frame that forms a portion of a printhead service station. The frame 322 may define a plurality of channels for introducing and draining a liquid solution when the printing element is parked against the parking element. In some embodiments, the channels may be defined by tubes. In a preferred embodiment, the frame may be constructed from stainless steel or a plastic material that is stiff enough to support the flexible parking element under the load imposed by parking the printhead. Channels for carrying fluid to and from the parking element may, for example, be sealed by hoses and hose-barbs or compression fittings attached to inlet points molded into the parking element. Tubes may, for example, have an inside diameter approximately the size of the slot in the dogbone gasket, and may project vertically downward from the inlet and outlet orifices disposed in the parking element.

In an exemplary configuration, the frame may include a fluid supply and drain to flush away accumulated dust. The design of the dogbone gasket 208 accommodates all to the complexity of the lower extent of the printhead and printing element 204. The dogbone gasket 208 provides an interface to a more simplified surface that includes the parking element 210. A simple geometry for the parking element 210 may be a flat sheet of flexible rubber. That shape is relatively easy to clean, and allows the printhead to park within a broad area without the need to register with any special topography. As an example, in FIG. 2d the parking element 210 is drawn as a straight line that represents a planar surface.

The printhead is the travelling component of the 3D printing system. A robot effects the motion of the printhead during the manufacturing of 3D printed parts. A suitable robot is, for example, an IRB 260 or an IRB 140 industrial robot manufactured by ABB, Inc.

The service station is a stationary component that rests outside of the build area of the machine, but inside the region where the robot is capable of moving the printhead. When it is desired to park, clean, prime, or wipe the printhead, the robot may be used to move the printhead to the appropriate component of the service station.

The lip of the gasket surrounding the slot provides a surface away from the printing element where ejected powder can collect and be easily wiped away without contacting (and possibly damaging) the orifice plate.

The soft, flexible material from which the gasket 206 is made is chosen to easily shed foreign material. Particularly useful materials for this component are chemically resistant hydrophobic elastomeric materials such as natural or synthetic rubber, EPDM rubber, fluoroelastomers such as VITON, polydimethylsiloxane, and associated polymers.

Advantageously, the projecting lip of the gasket 206 provides a useful feature for capping a printhead (or printing element) when it is not in use. In an embodiment, a parking station 210 is provided, including a flat sheet of flexible rubber that may be made from a material chosen from the same set as that given for the gasket, i.e., natural or synthetic rubber, EPDM rubber, fluoroelastomers such as VITON, polydimethylsiloxane, and associated polymers The printhead is capped by moving the printhead to a point over the flat sheet and lowering it vertically until the flat sheet compresses against the lips of the gaskets 206 that surround the orifice plates of the individual printing elements 204.

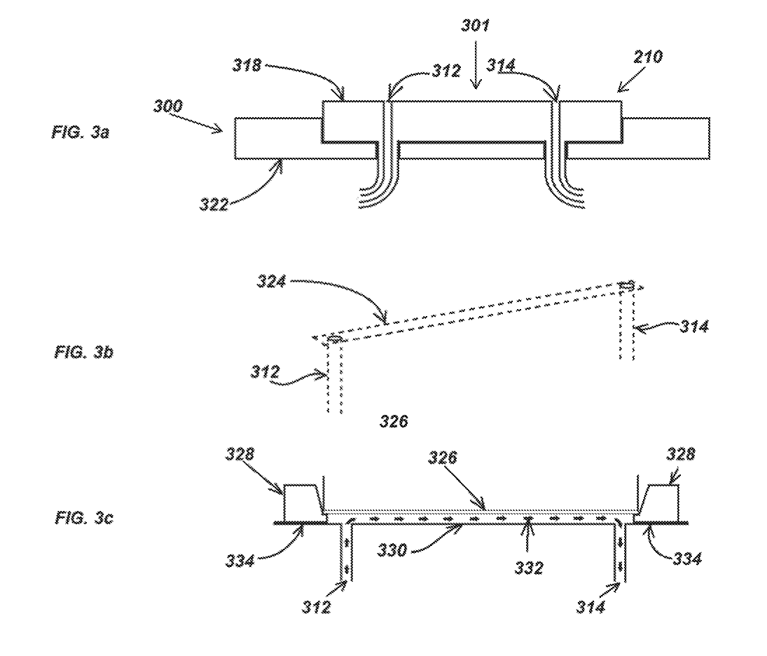

Referring to FIG. 3a, a portion of the parking element is shown in cross section. The parking element 210 may be integrated into a service station 300. A top surface of the parking element 210 may include an irrigation site 301 where wash fluid may be supplied to the space adjacent to the orifice plate. This irrigation site may include a plurality of fluid connections, including at least one fluid supply orifice 312, and at least one drain (or outlet) orifice 314. The seal between the parking element 210 and the dogbone gasket 208 provides containment of a washing fluid that may be supplied externally from the printhead. The parking element 210 may include a flexible body 318. A portion of the parking element is supported by a solid frame 322 that is attached to a fixed service station outside of the print area. As discussed above, the frame 322 defines a plurality of channels (or tubes) for introducing and draining a liquid solution when the printing element is parked against the surface of the parking element.

In a typical washing operation, the printhead is parked with the slot in the dogbone gasket aligned with the two orifices, 312, 314, in the irrigation site 301. The washing fluid may be supplied under a modest pressure to the space such that particles of dust or deposits ejected from the build area are dissolved or carried away from the orifice plate. A suitable washing fluid is, e.g., a low-viscosity solvent whose action serves to soften solidified deposits on the printhead, such as water containing a surfactant, alcohol, ethoxy ethanol, or dipropylene glycol monomethyl ether. The washing fluid may be supplied through a tube connection to the fluid supply orifice 312 on the upper surface of the parking element. Excess fluid may be drained from the space through the drain orifice 314, to a waste collection system via, e.g., a tube connection (not shown). Most preferably, the two orifices 312, 314, in the illustrated embodiment are located at points on opposite ends of the orifice plate.

Referring to FIG. 3b, an area of contact between a dogbone gasket and irrigation site on the service station is illustrated, including a contour 324 of a line of contact between a gasket slot and a flat surface of an irrigation site. An inlet channel 312 for wash fluid (or storage fluid) is disposed at one point of the area of contact, and an outlet channel 314 for wash or storage fluid and ink purge is disposed at another point at the area of contact.

Referring to FIG. 3c, a cross section of a portion of the orifice plate and the irrigation site on the service station is illustrated. A section 328 of the dogbone gasket is in contact with the orifice plate 326, with an area of contact 334 defined between the dogbone gasket and the irrigation site. A channel 330 is formed by the slot in the dogbone gasket and the flat surface of the irrigation site. The channel includes an inlet 312 for wash fluid and an outlet or drain 314 for wash fluid and ink. The direction 332 of flow of wash fluid during pumping is from the inlet to the outlet through the channel 330.

In use, a printing element may be washed as follows. The 3D printing apparatus described may be positioned against the service apparatus described above such that the channels 312, 314 are in fluidic communication with a space 324 between the gasket and the orifice plate of the printing element. A fluid is supplied from at least one channel to the space between the gasket and the orifice plate. A vacuum or fluid drain to the channel or tube is provided. The fluid is subsequently drained away.

Service station functions that may be provided by embodiments of the invention include:

1. Capping: During times when the printhead is idle, for example, when other components of the machine are undergoing maintenance, the printhead is preferably protected from the ambient environment. Configurations in accordance with embodiments of the invention permit the capping element to have a very simple shape that is easy to keep clean, e.g., a surface of a flat rubber sheet.

2. Wiping: By providing a non-sticky target for the majority of dust deposits to collect, embodiments of the invention facilitate cleaning of the outside of the printhead.

3. Protection: The gasket provides a fluid-tight seal against the orifice plate that excludes washing fluids from the fragile electronic components of the printing elements.

4. Washing: Fluids supplied to the orifice plate to facilitate cleaning are confined to the area where they are most needed. Washing fluids may be supplied externally, or they may be supplied from the printing elements by pressure priming.

The presence of an external source of wash fluid and drainage in close proximity to the orifice plate offers numerous opportunities for efficiently cleaning and preserving the printing elements. Besides the irrigation method described above, one may additionally use the printing element itself as a source of fluid by forcing ink out through the orifice plate into the irrigation site. Alternatively, one may use the printing element as a drain for the wash fluid. In the former case, the strategy is useful for removing particles of material that may have become lodged on the outer surface of the orifice plate. In the latter case, the wash fluid may be used to perform some detergent action on the interior channels of the printing element to dislodge, for example, deposits that may have accumulated from drying of the ink.

The mixing of the wash fluid and the ink during the process described above may be utilized to provide some further benefit. A chemical reaction may be caused to occur between the ink and the wash fluid when the two are mixed during irrigation. The wash fluid may contain an inhibitor for the solidification reaction that softens deposits on the orifice plate; and it may also include a buffer to adjust the pH of the mixed ink and wash fluid for purposes of dispersing particles.

One may additionally use acoustic energy to further stimulate the dispersion and/or softening of deposits in the presence of the wash fluid. A suitable acoustic energy source may be piezoelectric elements that may be included in the printing element.

For purposes of preserving the printing elements during occasional idle periods, a mechanism may be provided for replacing the ink in the printing elements with an inert storage fluid that displaces reactive inks with a medium in which the printing elements can rest for long periods, e.g., several days to a few months without damage.

A procedure for preparing a printing element for storage may be as follows:

1. Provide a 3D printing apparatus, including a printhead having a printing element, a manifold configured to receive the printing element, and a gasket disposed proximate the printing element.

2. Position the printhead against the service station 300 by moving the printing element against the parking station of the service station, over the irrigation site 301 that is configured to supply an inert, nonvolatile storage fluid that is miscible in an ink disposed in the printhead after use, e.g., after 3D printing. For example the storage fluid may be diethylene glycol, propylene glycol, or polyethylene glycol, and the ink may be CSTRed available from 3dbotics, Inc of Woburn, Mass.

3. Irrigate the space outside the orifice plate of the printhead with the storage fluid by supplying the storage fluid;

4. Apply a vacuum to fluid channels inside the printing element to cause the storage fluid to enter the channels inside the printing element;

5. Supply a quantity of the storage fluid sufficient to dilute an ink inside the printing element by no less than one volume of storage fluid per volume of ink, thereby replacing at least a portion of an ink disposed in the printing element;

6. Stop the supply of storage fluid;

7. Optionally one may seal the printing element by parking against a flat portion of the parking station.

If the printhead is to be stored for a relatively long period of time, for example, more than a few days, it may be desirable to either resupply the printhead with storage fluid periodically or to close off the ink supply with a valve or stopcock to prevent the ink from migrating back into the printing elements through the ink supply. When service is resumed, the storage fluid may be purged from the head either through internal channels in the head or out of the head into a drain.

Those skilled in the art will readily appreciate that all parameters listed herein are meant to be exemplary and actual parameters depend upon the specific application for which the methods and materials of the present invention are used. It is, therefore, to be understood that the foregoing embodiments are presented by way of example only and that, within the scope of the appended claims and equivalents thereto, the invention may be practiced otherwise than as specifically described.

What is claimed is:

1. A 3D printing apparatus, comprising:
a printing element;
a manifold configured to receive the printing element; and
a gasket disposed proximate the printing element,
wherein (i) the manifold and gasket together enclose the printing element, and (ii) the gasket defines a liquid-tight seal that isolates the printing element from ambient.

2. The 3D printing apparatus of claim 1, wherein the gasket comprises a highly flexible, hydrophobic material.

3. The 3D printing apparatus of claim 2, wherein the material is selected from the group consisting of natural rubber, synthetic rubber, EPDM rubber, fluoroelastomers, and polydimethylsiloxane.

4. The 3D printing apparatus of claim 1, wherein the gasket comprises a flexible component coupled with a rigid support.

5. The 3D printing apparatus of claim 1 wherein the gasket is adapted to become distorted when it is mated to the printing element in an interference fit, the distortion causing the liquid-tight seal to become compressed at an interface between the gasket and the manifold.

6. The 3D printing apparatus of claim 1, further comprising a robot adapted to move the printing element, manifold, and gasket.

7. The 3D printing apparatus of claim 1, further comprising the robot is adapted to move a plurality of assembled printing elements, manifolds, and gaskets.

8. The 3D printing apparatus of claim 1, further comprising a service station adapted to service the printing element.

9. The 3D printing apparatus of claim 8, wherein the service station comprises a parking element having at least one surface.

10. The 3D printing apparatus of claim 9, wherein the surface comprises a flat surface.

11. A method for capping a printing element , the method comprising the steps of:
a) providing a 3D printing apparatus comprising
a printing element,
a manifold configured to receive the printing element,
a gasket disposed proximate the printing element, and
a service station adapted to service the printing element, the service station including a parking element having at least one surface,
wherein (i) the manifold and gasket together enclose the printing element, and (ii) the gasket defines a liquid-tight seal that isolates the printing element from ambient,
b) positioning the printing element against the surface of the service station;
c) pressing the printing element against the surface, wherein the surface compresses the gasket to tighten the liquid-tight seal.

12. A service apparatus for washing a printing element, the apparatus comprising:
a parking element having at least one surface, and
a frame defining a plurality of channels for introducing and draining a liquid solution when a printing element is parked against the surface of the parking element.

13. The service apparatus of claim 12, wherein the surface comprises a flat surface.

14. A method for washing a printing element, the method comprising the steps of:
a) providing a 3D printing apparatus comprising
a printing element,
a manifold configured to receive the printing element, and
a gasket disposed proximate the printing element,
wherein (i) the manifold and gasket together enclose the printing element, and (ii) the gasket defines a liquid-tight seal that isolates the printing element from ambient,
b) positioning the 3D printing apparatus against a service apparatus comprising
a parking element having at least one surface, and
a frame defining a plurality of channels for introducing and draining a liquid solution when the printing element is parked against the surface of the parking element, wherein the channels are in fluidic communication with a space between the gasket and an orifice plate of the printing element;
c) supplying a fluid from at least one inlet channel to a space between the gasket and the orifice plate;
d) applying a negative pressure to an outlet channel; and
e) draining the fluid through the outlet channel.

15. The method of claim 14, wherein supplying the fluid comprises pressurizing the fluid in the printing element.

16. The method of claim 14, wherein the printing element applies the negative pressure.

17. The method of claim 14 wherein a first fluid is supplied through the at inlet channel, a second fluid is supplied through the printing element, and the product of reaction between the two fluids effects cleaning of an orifice plate on the printing element.

18. The method of claim 14, further comprising applying acoustic energy from an acoustic energy source to the fluid occupying the space between the gasket and orifice plate.

19. The method of claim 18 wherein the source of acoustic energy comprises a piezoelectric actuator of the printing element.

20. A method for preserving and storing a printing element comprising the steps of:
a) providing a 3D printing apparatus comprising
a printing element,
a manifold configured to receive the printing element, and
a gasket disposed proximate the printing element,
b) positioning the 3D printing apparatus against a service apparatus comprising
a parking element having at least one surface, and
a frame defining a plurality of channels for introducing and draining a liquid solution when the printing element is parked against the surface of the parking element,
wherein the channels are in fluidic communication with a space between the gasket and an orifice plate of the printing element; and
c) supplying a storage fluid from at least one channel to the space between the gasket and the orifice plate.

21. The method of claim 20, further comprising:
applying a vacuum to the printing element, to cause the storage fluid to replace at least a portion of an ink disposed in the printing element, the storage fluid comprising a nonvolatile, inert solvent miscible with the ink, wherein the ink comprises a binder for 3D printing.

22. The method of claim 21, further comprising:
e) positioning the printing element against an impermeable surface to seal the storage fluid within the printing element.

23. A 3D printing apparatus, comprising:
a manifold configured to receive a printing element; and
a gasket disposed at a lower portion of the manifold,
wherein (i) the manifold and gasket are adapted to together enclose the printing element, and (ii) the gasket defines a liquid-tight seal that isolates the printing element from ambient.
